(19) United States
(12) Patent Application Publication
(10) Pub. No.: US 2010/0166169 A1
(43) Pub. Date: Jul. 1, 2010

(54) SYSTEM AND METHOD FOR PROMOTIONAL CALLING

(75) Inventor: George Joy Man Ma, Millbrae, CA (US)

Correspondence Address: NIXON PEABODY, LLP, 401 9TH STREET, NW, SUITE 900, WASHINGTON, DC, 20004-2128, US

(73) Assignee: APEXTALK HOLDINGS, INC., San Francisco, CA (US)

(21) Appl. No.: 12/371,454

(22) Filed: Feb. 13, 2009

Related U.S. Application Data
(60) Provisional application No. 61/142,145, filed on Dec. 31, 2008.

(51) Int. Cl. H04M 3/42; G06Q 30/00

(52) U.S. Cl. 379/216.01; 705/14.4

(57) ABSTRACT

Systems and methods for integrating business promotional material with voice calling are described. The business sponsors a customer to sign up for an outgoing calling account with a promotional calling service provider company. The service provider identifies an user as a customer of the sponsor and therefore assigns one dedicated speed dial extension to connect directly to the sponsor. Other frequently called numbers are stored in a phone book at other speed dial locations. Sponsor gets to promote themselves to the sponsored user when the user sets up/maintains his/her online account or makes a call.

### CROSS REFERENCE TO RELATED APPLICATIONS

This application claims the benefit of U.S. Provisional Application No. 61/142,145, filed Dec. 31, 2008, entitled “SYSTEM AND METHOD FOR PROMOTIONAL CALLING,” the entirety of which is hereby incorporated by reference.

### BACKGROUND

1. Field of the Invention

This invention relates generally to communication methods and systems, and more specifically, to integrating business promotion with internet and telephony.

2. Related Arts

Businesses traditionally use various media channels, such as, television, radio, newspaper, magazines, the Internet, etc, to promote their brand and/or specific products. However, even with heavy promotion, it is difficult for the businesses to have their customers “memorize” their phone numbers.

From the user/customers' perspective, it is virtually impossible to memorize of all the business contact numbers that he/she may need to call, even if the user sets up, organizes, and regularly maintains a phone book physically or electronically. In conventional communication systems, speed dialing option is available, where the user assigns speed dial extensions to his/her most frequently-called phone numbers, that may include business contacts and/or personal/social contacts.

It is likely that the user will be more attracted towards a business, if the business provides an easy way for the user to get connected to the business without having to memorize the business's contact number. At the same time, the user is likely to expect some convenient service from the business in exchange of his/her patronage and loyalty.

Therefore, what is needed is a system that caters to both the business entity and its customers by simultaneously allowing the customer to enjoy speed dial services, and allowing the business entity to promote itself while the customer is using the speed dial service.

### SUMMARY

The following summary is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to certain aspects of the invention, a system for providing sponsored users prompt connection to a plurality of destination phone numbers comprises: a content module for storing promotional material from a sponsor; an interfacing module for receiving a dialed personal access phone number; a control module for presenting at least a portion of the stored promotional material to the sponsored user when the personal access phone number is received; a speed dial extension module for accessing the plurality of destination phone numbers stored at corresponding speed dial locations; and a switching module coupled to the speed dial extension module for directing a call to a destination phone number, when the sponsored user dials the corresponding speed dial extension. The switching module may be part of the system, or may receive instruction from the system to route a call.

According to other aspects of the invention, a method for providing sponsored users prompt connection to a plurality of destination phone numbers comprises: providing a personal access phone number to a sponsored user; presenting promotional material to the sponsored user when the sponsored user dials the personal access phone number; accessing the plurality of destination phone numbers stored at corresponding speed dial locations, when the sponsored user dials in a speed dial extension; and directing a call to the destination phone number corresponding to the dialed speed dial extension.

Aspects of the present invention also include a method of providing sponsored users prompt connection to a plurality of destination phone numbers, comprising: providing a promotional code from the sponsor to the sponsored user; accepting the promotional code, when the sponsored user sets up a personal account by visiting a primary web location; presenting web-based promotional material at the web location when the sponsored user sets up his/her personal account; storing the plurality of destination phone numbers at corresponding speed dial locations; providing a personal access phone number to a sponsored user; presenting additional promotional material to the sponsored user when the sponsored user dials the personal access phone number; accessing the plurality of destination phone numbers stored at corresponding speed dial locations, when the sponsored user dials in a speed dial extension; and

directing a call to the destination phone number corresponding to the dialed speed dial extension.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrates an example Promotional Calling System (PCS), according to an embodiment of the present invention.

FIG. 2 illustrates an example network environment, where a PCS may be implemented, according to another embodiment of the present invention.

FIGS. 3 and 4 illustrate various example components of an IP Gateway Application Server and a Phone Gateway Application Server/Switch, according to embodiments of the present invention.

FIG. 5 illustrates a flowchart showing a process of an user's web experience associated with PCS, according to an embodiment of the present invention.

FIG. 6 illustrates a flowchart showing a process of an user's call experience associated with PCS, according to an embodiment of the present invention.

FIGS. 7A-7B illustrate example pre-paid phone cards associated with PCS, according to embodiments of the present invention.

### DETAILED DESCRIPTION

### Overview

Even with substantial promotion on regular media channels, it is very difficult for any business to have most of their customers remember the business phone number. The subject invention provides a solution, frequently referred to herein as a Promotional Calling System (PCS). PCS enables a business/sponsor to have their customers/users utilize a communication application that facilitates “memorizing” the sponsor's contact phone number and enables the user to contact the sponsor promptly. PCS also helps in securing customer loyalty for the business/sponsor.

PCS is a speed dial telephony service which a business or enterprise sponsors for its customers to use in exchange of being exposed to the sponsor's promotional materials while using the speed dial service. In other words, sponsors can buy PCS service and provide them to their customers, i.e. sponsored users. Sponsored users gets a promotional code from the sponsor, accesses PCS system's website, sets up a personal account, stores his/her most frequently dialed phone numbers as speed dial entries in a phone book included in the PCS system, and receives a personal access phone number, which is a unique phone number. While setting up/maintaining personal account, the sponsored user sees sponsor's promotional material. The sponsored user then dials the personal access phone number to get connected to the PCS system, and can reach the sponsor and/or other destination numbers stored as speed dial entries. Once again, while calling the sponsor and/or other destination numbers using the PCS personal access phone number, the sponsored user hears/sees the sponsor's promotional material. Thus, using PCS, a business entity or sponsor can cut down significantly on its promotional effort through regular media /sales channels. Moreover, the sponsor's contact number is already stored in the PCS phone book as a pre-defined speed dial entry. Thus, the customer will be able to “remember” the business phone number easily while using the sponsored speed dial service.

Below, we describe how a user can use the PCS service, and how a business/sponsor can utilize the PCS system to promote their business to the sponsored users.

In the subsequent description, “Business” or “Sponsor” refers to the participating business entity that uses the service provider systems to market and promote themselves. Similarly, the terms “customer” and “user” are used interchangeably to refer to a person who is sponsored by a business and uses the PCS service.

### Account Origination by User

A sponsored user receives a promotional code or personal index number (PIN) from the sponsor via some means, including, but not limited to, a Promotional Calling Card, a VIP card, a membership card, postal mail, e-mail, SMS, voice message, etc. The user then logs online to a primary web site maintained by the PCS service provider, inputs the promotional code or PIN to setup his/her account. For example, for the PCS service provider Apextalk, the user may log on to a primary website www.apextalk.com.

While signing up, the user may have the option to select his/her personal access phone number from a pool of available access numbers. Each user will have a unique personal access phone number.

The user stores his/her most frequently dialed phone numbers as speed dial entries. From this stage on, when the user calls his/her desired contacts, such as, overseas business associates, friends and relatives, the user can use the advantage of a speed dial service. The user can also change login information or other profile information once an online account is set up. This way, the user does not have to memorize the promotional code.

Because of the user convenience, users are likely get used to the PCS service and stick with this system and keep on using it, even after the free promotional minutes, i.e. sponsored calling minutes bought by the sponsor and associated with the promotional code, are used up. Users may keep paying for themselves to use this service. Alternatively, the sponsor has an option to renew the promotional account for the user to promote user loyalty. By dialing the pre-assigned sponsor-dial extension, users are able to connect to the sponsor promptly.

The user can update, or change their speed dial extensions to any phone numbers, but typically, the system does not allow the user to change the dedicated sponsor-dial extension. Also, any time when the user accesses his/her online account to change the phone number and speed dial entries, to add calling time, or to modify user profile on PCS, the user sees the sponsor's promotional information. Thus, the sponsor effectively uses the PCS service as an online advertising tool.

### Placing a Call by User

Once the account has been set up, to place a call using the PCS service, the user dials his/her unique personal access phone number. PCS identifies the personal access phone number and associates the user to the corresponding sponsor. PCS then plays out the voice prompt of the sponsor's greeting as part of the welcome or introductory message heard/seen by the user. This way, the sponsor gets to advertise themselves to the user. The user then keys in a speed dial extension to make calls to a desired receiving party.

In the event the user wants to call the sponsor, he/she simply needs to dial his/her personal access phone number and press the pre-assigned sponsor-dial extension, such as “0”, so that the call is routed to the sponsor's' phone number promptly. The user no longer needs to remember the sponsor's phone number. The user simply remembers his/her own personal access phone number, or may program the personal access phone number to his/her device from which the call is placed.

### Business Promotion by Sponsor

A PCS service provider provides a plurality of promotional codes or personal index numbers (PIN) to a business who buys or subscribes to PCS service as a sponsor. A sponsor distributes the promotional codes or PINs to its customers, i.e. the sponsored users. Based on the promotional code or PIN, PCS is configured to identify the participant sponsor and brings up the sponsor's sign-up pages including the sponsor's promotional material when the user sets up his/her personal account. A content server may upload the sponsor's relevant marketing information onto the signup website. The sponsor's customized web pages are stored in a sub-directory of the PCS service provider's primary website. It is possible to further customize or personalize the sponsor web pages by identifying the user through the PIN that he/she is using, if user information is known beforehand.

PCS may automatically assign the sponsor's contact number to the preset entry location—for example—the “0” entry. Any other speed dial location may be used to store the sponsor's phone number.

Sponsors have controlled authorization to log onto the administration page maintained by the PCS service provider to customize their promotional material. “Promotional Material” refers to any graphical, audio, visual, audio-visual, hypertextual, or other multimedia-delivered material that promotes a business. Promotional materials include, but are not limited to, business logo/banner, marketing/sales information, specific product-related or service-related information, corporate information, important press releases, business blog, advertisement, etc.

Example administrative options available for the sponsor include, but are not limited to, changing the phone number on pre-assigned sponsor-dial entry; updating and uploading most relevant marketing and product information; reviewing customers' feedbacks online; collecting customers' email address and/or other contact information; sending email to their customers through PCS; reviewing periodic usage pattern of promotional minutes; requesting additional promotional code (PIN) and/or prepaid “calling time” from the PCS service provider, etc.

The sponsor pre-records its voice prompt (as part of the welcome message) by either calling into PCS over the regular phone line or uploading a pre-recorded audio file to PCS system.

Sponsors have the option to access an Interactive Voice Response (IVR) system integrated to the PCS system to further interact with their customers. In an embodiment, an enhanced IVR system can further direct users on how to proceed. For example, the user may make an appointment with the sponsor. The enhanced IVR provides an interactive environment for the sponsor to offer better customer service.

Another enhanced program on PCS available to the sponsor is to put sub-extensions after the designated speed dial extension or sponsor-dial extension, for example, extension “0”. Sponsors can get a stand-alone system away from their main office phone switch and using the PCS service provider's system to have pre-recorded voice prompts guide customers to access more information. This way a sponsor can interact with the PCS to service the customer on the spot. The PCS system is configured to provide a Private Branch Exchange (PBX) capability to a sponsor, whether the sponsor has its own PBX or not.

For example—after a user keys in “0”—voice prompt will announce “Welcome to ABC Hotel”, Press “1” for booking the rooms, Press “2” for restaurants, Press “3” for entertainment programs, etc. When “2” is pressed, customer will hear another voice prompt—“to book a table, please press “1”, this will route the call directly to the restaurant's reception for reservation. This stand-alone system can be integrated along with Sponsor's main phone switch and support the customers in a way that will enhance Sponsor's business substantially.

In certain embodiments, when the user dials his/her personal access phone number, the phone screen may display sponsor's promotional information, provided the user's phone and the communication network (i.e., the wireless and/or the land line telephone network) are configured to support such an application.

### Example Communication Environment and System Implementation

The present invention utilizes the existing capability of an already-deployed wireless infrastructure, telephone network infrastructure, and Internet Protocol (IP) network infrastructure. The present invention is agnostic to the type of telephone network. For example, the present invention can be implemented in a Voice-over-Internet-Protocol (VOIP) network, but is not limited to VOIP implementations. An example embodiment of the present invention may use the audio and video capability of a current third generation (3G) mobile network infrastructure with the capability to adapt to future generations of wireless networks.

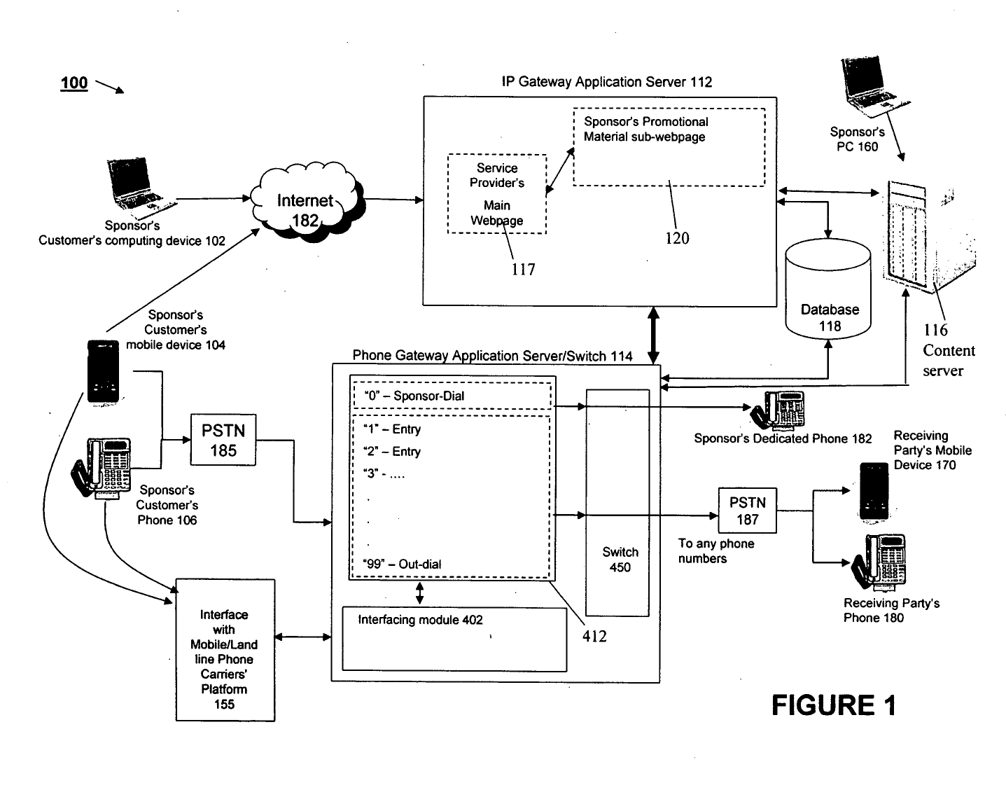

FIG. 1 shows an example system embodiment 100 combining an example PCS system and example network environment, according to the present invention. System 100 is illustrative and not intended to limit the invention.

The example PCS system has two primary components: a IP Gateway Application Server 112, and a Phone Gateway Application Server/Switch 114. Server 112 and server/switch 114 communicate with each other. A database 118, and a content server 116 may be coupled to both server 112, and server/switch 114.

A sponsor's PC 160 or a sponsor's server (not shown) uploads promotional materials to server 116, and server 116 uploads or channels promotional material to sponsor's customized sub-webpages 120 hosted by server 112. Server 112 also hosts PCS service provider's primary web page 117. When a user logs on to web page 117, PCS navigates the user to the sponsor's customized sub-webpages 120.

Database 118 stores a host of phone numbers, sponsor information, customer/user information etc., and can be accesses by the PCS system as required.

A sponsored user/customer may log on to the PCS system using his/her Computing device 102 (such as, a desktop or laptop personal computer, a smart phone, etc.) or other web-enabled device through the Internet 182. For example, a sponsored user/customer's mobile device 104 may be connected to server 112 via the Internet 182, if mobile device 104 is web-enabled. The sponsored user logs on to server 112 to set up and maintain his/her account. The sponsored user stores frequently dialed phone numbers at specific speed dial locations.

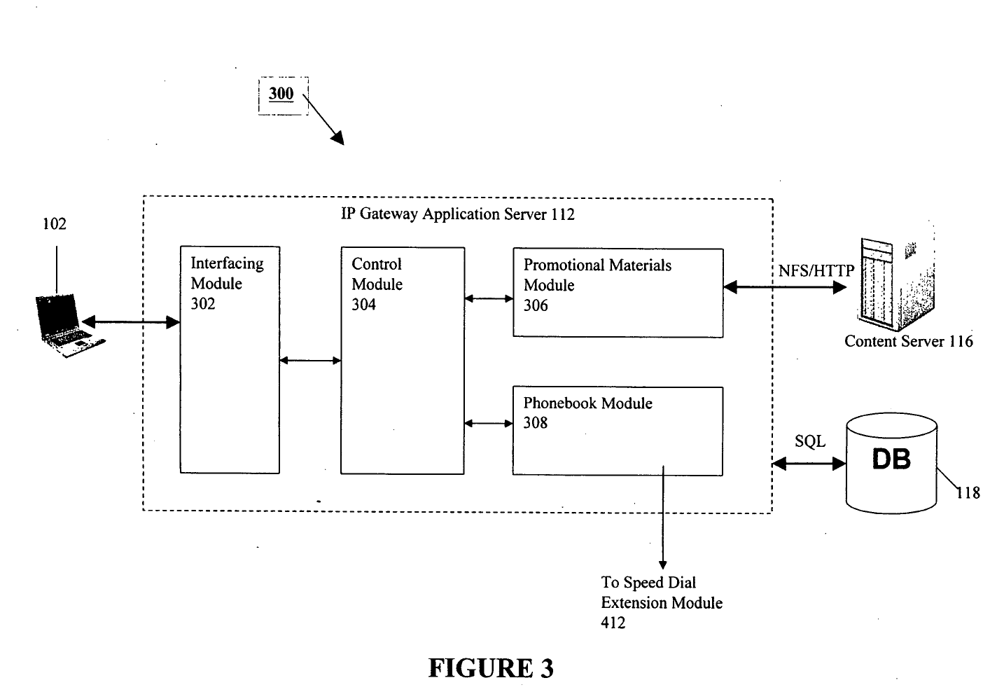

Example hardware and/or software-implemented system components of server 112 are discussed later with respect to FIG. 3.

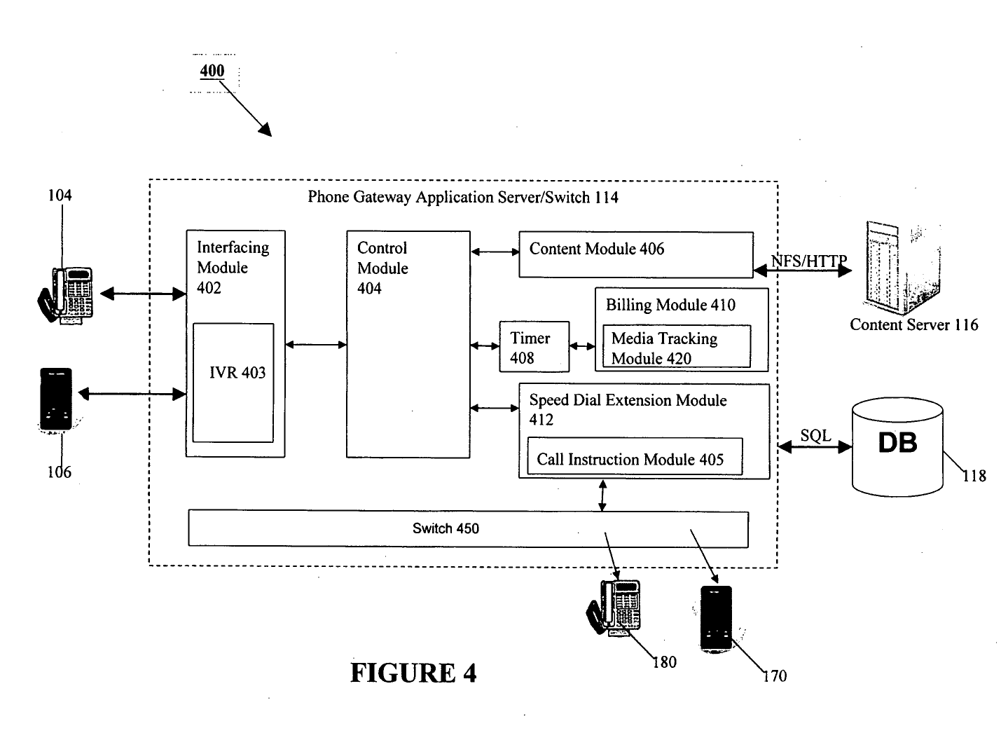

Server/Switch 114 has a speed dial extension module 412, an Interface and Voice Prompt Module 402, and a switch 450, among other components. Details of the example components are discussed later with respect to FIG. 4. Note that switch 450 may be a part of the PCS system, or may be provided by an outside vendor, in which case, the PCS system is configured to send call routing instruction to the external switch 450.

A sponsored user may use his/her mobile device 104 or landline phone 106 to place a call to a receiving party's mobile device 170 or landline phone 180. The calls may be routed through PSTN network 185, server switch 114, PSTN 187, and any other communication gateway (not shown) that may be necessary to complete the connection. A special wireless/landline network may be used to place a call from the sponsored user's mobile device 104 bypassing PSTN 187 if a suitable communication interface 155 exists between the mobile device 104 or the landline phone 106 and server/switch 114.

As shown in the example PCS of FIG. 1, if the user dials ‘0’ (or any other pre-selected sponsor-dial extension) as the speed dial extension, the user is connected to the sponsor's dedicated phone line 182. The user is connected to other stored phone numbers when corresponding speed dial extensions (for example, ‘1’, ‘2’, . . . ) are dialed. Dialing extension ‘99’ (or any other pre-selected out-dial extension) enables the user to access additional phone numbers not stored at speed dial locations. Switch 450 routes different calls to the desired destinations.

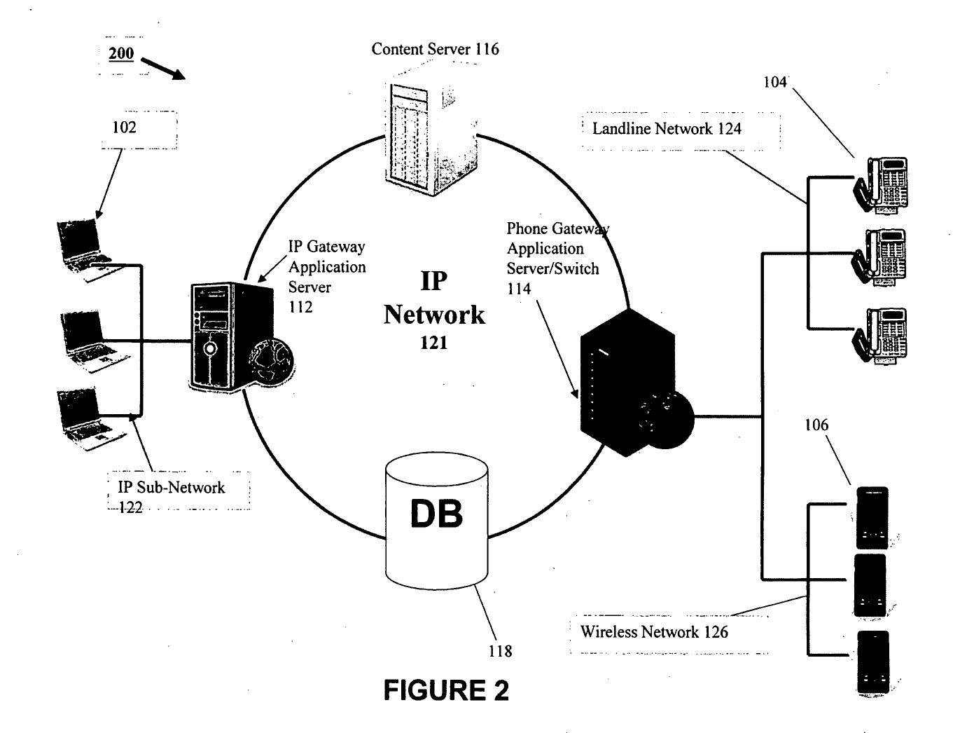

FIG. 2 shows an IP-based network environment 200, where the PCS service may be implemented. Network environment 200 includes a central IP network 121, to which IP Gateway Application Server 112, and Phone Gateway Application Server/Switch 114 are coupled to. Network environment 200 may include a number of computing devices 102 connected to an Internet Protocol (IP) sub-network 122; a number of landline phone devices 104 connected to a landline network 124, and a number of mobile phone devices 106 connected to a wireless network 126.

Computing devices 102 connect to IP Gateway Application Server 112. IP Gateway Application Server 112 is coupled to both Content Server 116 and Database 118. In an alternative embodiment, Content Server 116 may act as a repository to a Media Server (not shown) which then channels the audio and video contents to appropriate destinations. Database 118 stores information related to users (of computer devices, landline phones, and mobile phones). IP Gateway Application Server 112 executes a control logic that regulates the flow of content from Content Server 116 and Database 118 to computing devices 102. System 200 will display Sponsor's information on user's phone display (LCD or LED), while user dials his/her Personal access phone number, when mobile and landline phone carriers can support this type of application.

Any number of landline phone devices 104 may be connected to a landline network 124; any number of mobile phone devices 106 may be connected to a wireless network 126. Both landline network 124 and wireless network 126 interact with Phone Gateway Application Server/Switch 114. Phone Gateway Application Server/Switch 114 is coupled to both Content Server 116 and Database 118 (mentioned earlier). Phone Gateway Application Server/Switch 114 executes a control logic that regulates the flow of content from Content Server 116 and Database 118 to landline phone devices 104 and mobile phone devices 106, as well as directing and regulating call traffic through appropriate channels from phone devices to destination phones. Those appropriate channels can be implemented in a Voice-over-Internet-Protocol (VOIP) network, but is not limited to VOIP implementations.

FIG. 3 shows examples of the internal components of an IP Gateway Application Server 112, which communicates with computing device 102 through the IP Network 121 and IP sub-network 122. The IP Gateway Application Server 112 may also communicate with content server 116 using Network File System/Hypertext Transfer Protocol (NFS/HTTP) and database 118 via SQL or other database query language.

FIG. 4 shows examples of the internal components of a Phone Gateway Application Server/Switch 114, which communicates with both landline phone devices 104 as well as mobile phone device 106. The Phone Gateway Application Server/Switch 114 also communicates with content server 116 and database 118 using similar protocols as mentioned earlier. The protocols and languages shown in FIGS. 3 and 4 are included for illustrative purposes only. Other appropriate protocols may be used in alternative embodiments.

IP Gateway Application Server 112 may include an interface module 302, a control module 304, a promotional material module 306, and a phonebook module 308. IP Gateway Application Server 112 may have more components that are not shown in FIG. 3. Interface module 302 may include an Internet gateway to connect computing device 102 with server 112 via internet, and receives input (such as a sponsor-provided promotional code to set up an account, a list of phone numbers to be stored etc.) from the user. Promotional material module 306 stores promotional material, and establishes a channel to present customized promotional material to the user when the user logs on. Control module 304 controls the logic of presenting promotional material. For example, control module 304 identifies a user to be associated with a particular sponsor, and brings up that sponsor's promotional material. Control module 304 also provides the user with a personal access phone number associated with the sponsor. Control module 304 controls the flow of information from the server 112 to the user and vice versa. Phone book module 308 stores user's entries, i.e. stores phone numbers at assigned speed dial locations.

Phone Gateway Application Server/Switch 114 may include an interfacing module 402, a control module 404, a content module 406, a timer 408, a billing module 410, a speed dial extension module 412, and a switch module 450. Phone Gateway Application Server 114 may have more components that are not shown in FIG. 4. As mentioned before, switch 450 may be a part of the PCS system, or may be provided by an outside vendor, in which case, the PCS system is configured to send call routing instruction to the external switch 450.

Interfacing module 402 receives user input, such as the user-dialed personal access phone number. Interfacing module 402 also includes an Interactive Voice Response (IVR) module 403 to present customized welcome message and promotional message to the user when the user dials the personal access phone number. Control module 404 identifies the relevant sponsor from the personal access phone number, and controls the logic of presenting customized promotional material from content module 406. Control module 404 controls the flow of information from the server 114 to the user and vice versa. Speed dial extension module 412 communicates with phone book module 308 in the server 112 and accesses the data stored in phone book module 308 to determine what phone number to dial when a certain speed dial extension is dialed. Speed Dial extension module 412 may have a call instruction module 405 that instructs switch 450 how to route a call. Call instruction module 405 may be used as a PBX system for a sponsor. Switch 450 routes the outgoing calls to the destination number. Timer 408 and billing module 410 keep track of the service usage, and may cut off service if the user's account does not have enough money.

Billing module 410 may have a media tracking module 420 that gives feedback to the sponsor regarding the effectiveness of various advertising media, as explained later under the section heading “Media Tracker”.

Persons skilled in the art will appreciate that, without departing from the scope of the invention, various components of server 112 and server/switch 114 may be integrated together as a stand-alone system, or may be distributed into functional blocks that are different from what is shown in example FIGS. 3 and 4. However, the PCS system as a whole achieves the functionality as claimed and otherwise disclosed herein.

### Example Service Flow

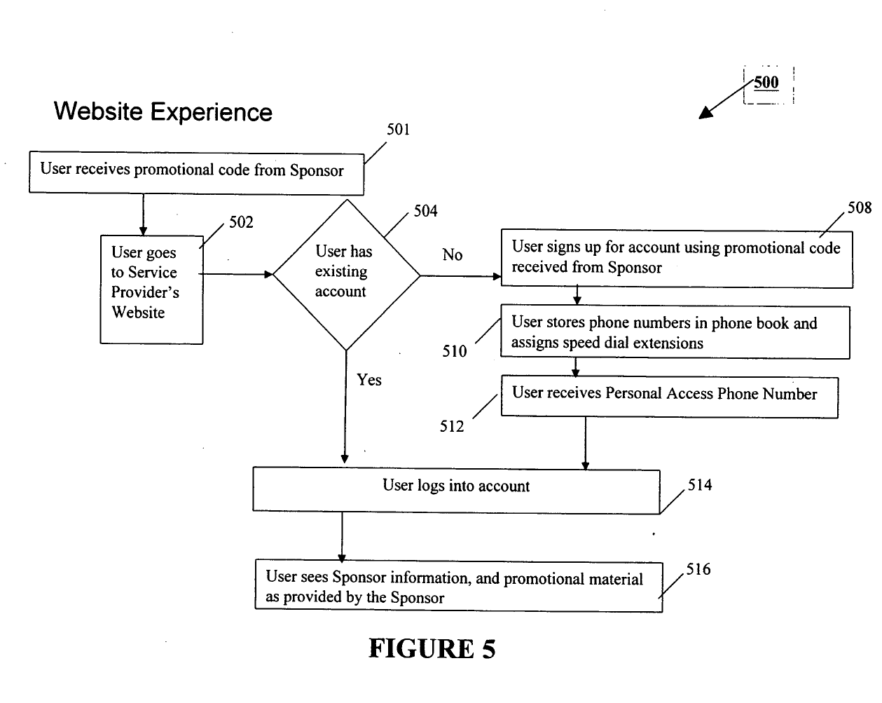

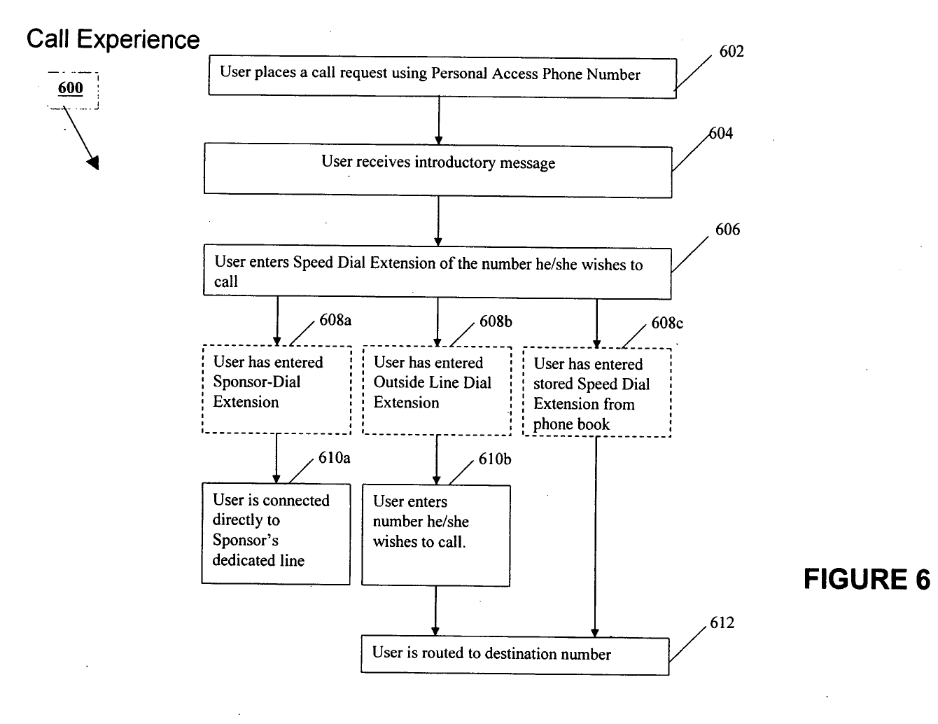

FIGS. 5 and 6 illustrate flowcharts that show example steps of the Promotional Calling System (PCS) from a user perspective, according to an embodiment of the present invention. These steps of the flowchart are for illustrative purpose only, and do not have to take place in the order shown. There may be additional intermediate steps that are not shown in FIGS. 5 and 6. Also, different embodiments may not use all of the steps shown in FIGS. 5 and 6. In example embodiments, components shown in FIGS. 3 and 4 may perform various steps of flowcharts 500 and 600.

In step 501 of flowchart 500, a user receives a promotional code from a sponsor. In step 502, the user goes to the PCS service provider's website using his or her computing device 102. Step 504 is an intermediate step that checks to see if the user has an existing account in the PCS. If the user does have an existing account, the user goes to step 514. However, if the user does not have an existing account in the system, the user goes to step 508, where he or she signs up for an account using the Sponsor's promotional code, such as a PIN. Before step 508, the user needs to receive a promotional code from the sponsor, as shown in step 501.

In step 510, the user may store a plurality of phone numbers in the web-based phone book, and save the most frequently dialed phone numbers at various speed dial locations.

In step 512, the user receives his/her personal access phone number, using which he/she can place a call. Note that the order in which steps 510 and 512 occur does not matter.

In step 514, the logs in to his/her account and in step 516, the user views his or her account page. This account page will display information about the Sponsor, as well as media and promotional advertising provided by the Sponsor. The user will also see details on how to reach the Sponsor by dialing the Sponsor's Dedicated Speed Dial Extension, often referred to as a sponsor-dial extension. User may add/delete stored phone numbers, or change speed dial locations based on updated priority of the user.

Flowchart 600 begins with step 602, in which a user dials his or her Personal access phone number (provided by the PCS) from a mobile phone device 106, a landline phone device 104, or a computing device 102 with VOIP.

In step 604, the user receives a welcome or introductory message. This message may be audio only, or, if the user is dialing from a video-enabled device, may include both audio and video. Additionally, the welcome message may be personalized to the user based on the user's sponsor.

In step 606, the user enters the speed dial extension of the number he/she wishes to reach. From here, the PCS can respond in one of three different ways depending on the speed dial extension that the user entered.

Step 608a describes a situation in which the user has entered the sponsor's designated speed dial extension, i.e. the sponsor-dial extension. If that is the case, in step 610a, the user is connected directly to the sponsor's dedicated line. In one embodiment, this means routing the user's phone call to a specific phone number provided by the sponsor. In an alternate embodiment, the user may be provided with a list of choices covering specific interactions through an Interactive Voice Response (IVR) system, such as IVR module 403 in FIG. 4. This IVR system will further direct user on how to proceed and interact with the sponsor.

Step 608b describes a situation in which the user has entered the outside line speed dial extension, referred to as an “out-dial” extension. If that is the case, in step 610b, the system allows the user to enter a number not previously set up in the user's speed dial extensions. The unstored number may be accessed from database 118.

In step 612, the user's phone call is routed to the destination number.

Step 608b describes a situation in which the user has entered a stored speed dial extension. This action leads directly to step 612, where the user's phone call is routed to that destination number corresponding to the speed dial extension.

The above steps are described for illustrative purposes only. Embodiments of the invention are not limited to the example steps, and may skip one or more steps, or follow additional intermediate or terminal steps, not shown here.

### Pre-Paid PIN

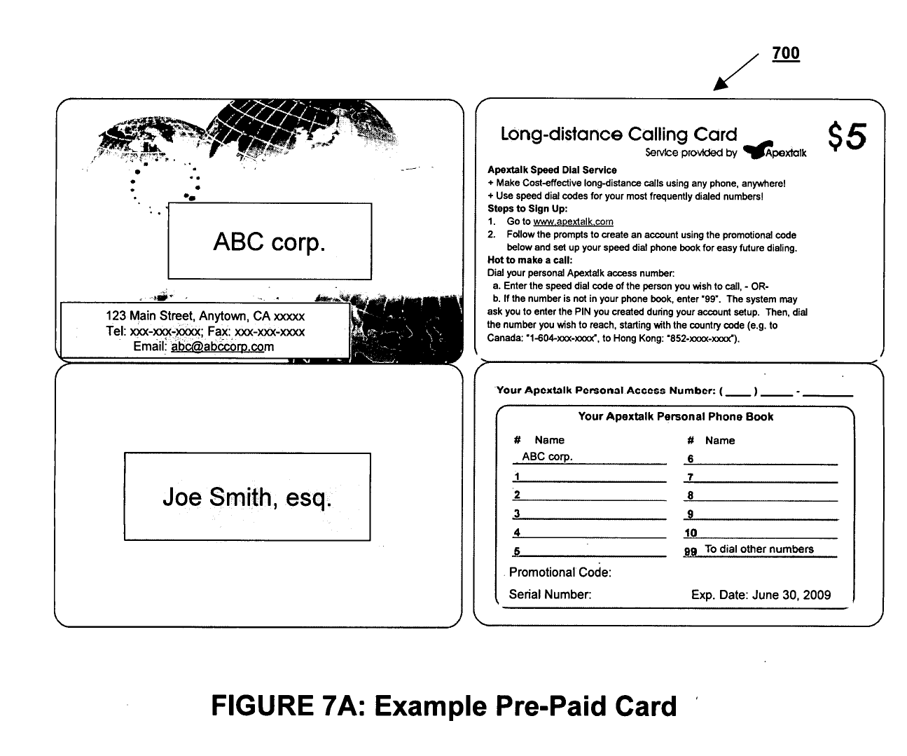

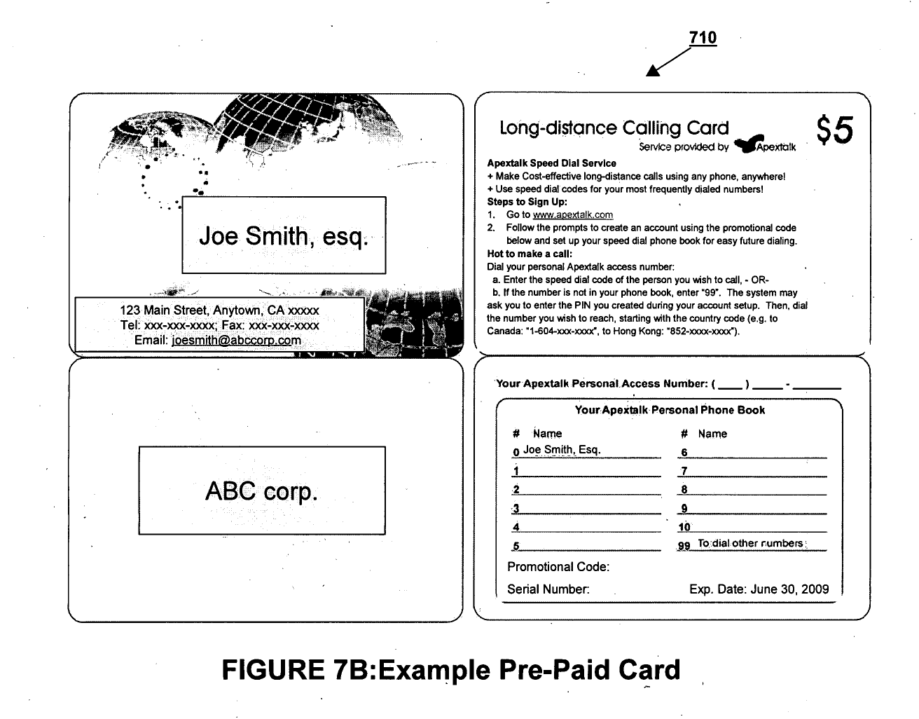

The sponsor has an option of giving out pre-paid physical calling cards associated with PCS. FIGS. 7A-7B show two different configurations 700 and 710 of example pre-paid calling cards of $5 value. The calling cards may have any amount of fixed or rechargeable stored value. The example calling cards work with PCS service provider, such as, Apextalk. In FIG. 7A, ABC corp. is the sponsor, and Joe smith is the customer. Thus, ABC Corp.'s number is stored at speed dial location “0”. In FIG. 7B, Joe Smith is the sponsor, and ABC corp. is the customer. Thus, Joe Smith's number is stored at speed dial location “0”. The PCS system helps promote business for corporate entities as well as individual practitioners and small businesses.

The value of each user account could be flexible for the pre-paid cards. The promotional code on the card may be used as a controlling code, that will identify the customer belonging to a certain Sponsor. Therefore, PCS system can monitor their activities and give feedback to the sponsor.

Prepaid calling PIN is available when Sponsor wants to refill their customers' account for repeating business. The value of the cards is $5, $10, $50 to $100s or any other value. Business buys the cards and has them available when either business/sponsor determines a need to attract customers by giving cards out and/or when customers ask for new card or refill when they patronize the sponsor's business again.

### Media Tracker

When a sponsor uses multiple advertising media to promote themselves, PCS can be used as a tool to for the sponsor to monitor which is the most effective media for marketing their products and services. The sponsor may assign different promotional codes for each advertising media, such as, TV commercials, radio spots, newspapers, magazines and leaflets. Therefore, when the sponsored user uses the promotional code to obtain a personal access phone number, PCS associates each personal access phone number to the relevant advertising media.

PCS may have a media tracker module to help a sponsor monitor call-records, determine the effectiveness of each advertising media from the call-records, and allocate the adverting budget accordingly. In the example embodiment shown in FIG. 4, media tracker module 420 may be included in billing module 410. Billing module 410 may generate call-record statistics and determine which advertising media generates the most effective usage from the sponsored users.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. For example, the Designated Speed Dial Extension may be routed to a stand alone voice prompt system which is separated from the Sponsor's main office phone switch. Various aspects and/or components of the described embodiments may be used singly or in any combination in the server arts. It is intended that the specification and examples be considered as exemplary only, with a true scope and spirit of the invention being indicated by the following claims.

1. A system for providing a sponsored user prompt connection to a plurality of destination phone numbers, comprising:
a content module for storing promotional material from a sponsor;
an interfacing module for receiving a dialed personal access phone number provided by the system to the sponsored user, the personal access phone number being associated with the sponsor;
a control module for presenting at least a portion of the stored promotional material to the sponsored user when the personal access phone number is dialed;
a speed dial extension module for accessing the plurality of destination phone numbers stored at corresponding speed dial locations when the sponsored user dials a speed dial extension; and
a switching module for directing a call to one of the plurality of destination phone numbers corresponding to the dialed speed dial extension.

2. The system of claim 1, wherein the system further comprises:
a phone number database coupled to the speed dial extension module, wherein the phone number database stores additional phone numbers not stored at speed dial locations.

3. The system of claim 2, wherein the speed dial extension module includes an out-dial extension reserved to enable access to the phone number database.

4. The system of claim 1, wherein the speed dial extension module includes a predetermined sponsor-dial extension reserved to connect the sponsored user to the sponsor.

5. The system of claim 1, further comprising:
a web application server hosting a primary web location where the sponsored user sets up and maintains a personal account using a promotional code provided by the sponsor.

6. The web application server of claim 5, further comprising:
a promotional material module for receiving and storing promotional material from the sponsor; and
a control module for presenting promotional material to the sponsored user when the sponsored user sets up or accesses his/her personal account.

7. The web application server of claim 6, wherein the promotional material module is configured to update its content when new or modified promotional material is received from the sponsor.

8. The web application server of claim 5, further comprising a phone book module to store the plurality of destination phone numbers at corresponding speed dial locations.

9. A method for providing a sponsored user prompt connection to a plurality of destination phone numbers, comprising:
providing a personal access phone number to a sponsored user;
identifying an associated sponsor when the sponsored user dials the personal access phone number;
presenting promotional material associated with the sponsor to the sponsored user;
accessing the plurality of destination phone numbers stored at corresponding speed dial locations, when the sponsored user dials a speed dial extension; and
directing a call to one of the plurality of destination phone numbers corresponding to the dialed speed dial extension.

10. The method of claim 9, further comprising:
reserving an out-dial extension to give the sponsored user access to a database of additional phone numbers not stored at any of the speed dial locations.

11. The method of claim 9, further comprising:
reserving a predetermined sponsor-dial extension to give the sponsored user access to a dedicated phone number of the sponsor.

12. The method of claim 9, wherein the method further comprises:
accepting a promotional code, provided by a sponsor to a sponsored user, when the sponsored user sets up a personal account by visiting a primary web location.

13. The method of claim 12, wherein the method further comprises:
storing the plurality of destination phone numbers at corresponding speed dial locations.

14. The method of claim 12, wherein the method further comprises:
presenting web-based promotional material associated with the sponsor to the sponsored user when the sponsored user accesses his/her personal account.

15. A system for providing sponsored users prompt connection to a plurality of destination phone numbers, comprising:
a content module for storing promotional material from a sponsor;
an interfacing module for receiving a dialed personal access phone number provided by the sponsor to the sponsored user;
a speed dial extension module for accessing the plurality of destination phone numbers stored at corresponding speed dial locations; and
a control module for presenting at least a portion of the stored promotional material to the sponsored user when the personal access phone number is received, and
a call instruction module for sending an instruction to direct a call to a destination phone number, when the sponsored user dials in the corresponding speed dial extension.

16. The system of claim 15, wherein the system further comprises:
a switching module for routing a call to a destination phone number, that receives an instruction from the control module.

17. The system of claim 15, wherein the system further comprises:
a phone number database coupled to the speed dial extension module, wherein the phone number database stores additional phone numbers not stored at speed dial locations.

18. The system of claim 17, wherein the speed dial extension module includes an out-dial extension reserved to enable access to the phone number database.

19. The system of claim 15, wherein the speed dial extension module includes a predetermined sponsor-dial extension reserved to connect the sponsored user to the sponsor.

20. The system of claim 15, further comprising:
a web application server hosting a primary web location where the sponsored user sets up and maintains a personal account using a promotional code provided by the sponsor.

21. The web application server of claim 20, further comprising:
a promotional material module for receiving and storing promotional material from the sponsor;
a control module for presenting promotional material to the sponsored user when the sponsored user sets up or accesses his/her personal account, and
a phone book module to store the plurality of destination phone numbers at corresponding speed dial locations.

22. The web application server of claim 21, wherein the promotional material module is configured to update its content when new or modified promotional material is received from the sponsor.
